(19) United States
(12) Patent Application Publication
(10) Pub. No.: US 2009/0295297 A1
(43) Pub. Date: Dec. 3, 2009

(54) OPTICAL FILTER AND PLASMA DISPLAY DEVICE HAVING THE SAME

(76) Inventors: Cha-Won Hwang, Suwon-si (KR); Do-Hyuk Kwon, Suwon-si (KR); Sang-Mi Lee, Suwon-si (KR); Seung-Goo Baek, Suwon-si (KR)

Correspondence Address: CHRISTIE, PARKER & HALE, LLP, PO BOX 7068, PASADENA, CA, 91109-7068, US

(21) Appl. No.: 12/474,152

(22) Filed: May 28, 2009

(30) Foreign Application Priority Data
Jun. 2, 2008 (KR) 10-2008-0051517

(51) Int. Cl. G09G 3/10; G02F 1/03

(52) U.S. Cl. 315/169.4; 359/242

(57) ABSTRACT

An optical filter and a plasma display device having the same is provided. The optical filter includes a support layer. A photochromic pattern has pattern elements spaced apart on a surface of the support layer and has a light transmission characteristic wherein light transmission is changeable according to the intensity of external light.

### CROSS-REFERENCE TO RELATED APPLICATION

This application claims priority to and the benefit of Korean Patent Application No. 10-2008-0051517, filed on Jun. 2, 2008, in the Korean Intellectual Property Office, the entire content of which is incorporated herein by reference.

### BACKGROUND

1. Field of the Invention

The present invention relates to flat panel displays, and, more particularly, to an optical filter used in a plasma display device.

2. Discussion of Related Art

A plasma display panel (PDP) is a flat panel display that displays characters or images by allowing a phosphor to emit light by means of plasma generated in the gas discharge. In recent years, the plasma display panel has emerged as a next-generation display device since it has inartificial color reproducibility, a short driving time and may be easily manufactured with longer-size and thinner scale than a cathode ray tube (CRT).

However, the PDP emits electromagnetic waves and strong near-infrared rays in the process of generating plasma using a high voltage, and therefore the electromagnetic waves and the strong near-infrared rays adversely affect human health or cause abnormal operations in the electronic equipment. The color purity may also be deteriorated by the near-infrared rays, which leads to the deteriorated image quality.

As a result, a method for installing an optical filter in a PDP has been used to cut off electromagnetic waves and near-infrared rays, reduce reflected light and enhance the color purity.

### SUMMARY OF THE INVENTION

In accordance with the present invention an optical filter capable of minimizing the luminance loss under the external light-free condition, and a plasma display device having the same, are provided.

Further in accordance with the present invention an optical filter capable of minimizing the luminance loss through the active reaction at external environments, and a plasma display device having the same, are provided.

Embodiments of the present invention provide an optical filter having a support layer. A photochromic pattern has pattern elements spaced apart on a surface of the support layer. The photochromic pattern has a light transmission characteristic wherein light transmission is changeable according to the intensity of external light. A reflection supporting layer may be formed on the other surface of the support layer. A transparent film may be on the photochromic pattern opposite the support layer. An electromagnetic shielding layer may be interposed between the transparent film and the photochromic pattern.

Another embodiment of the present invention is achieved by providing a plasma display device having the optical filter thereon. A first substrate has a plurality of display electrodes on the first substrate. A second substrate has a plurality of address electrodes on the second substrate. Barrier ribs are both between the first substrate and the second substrate and between the address electrode lines. Phosphor layers are on the barrier ribs. The first substrate and the second substrate are attached to each other and have the display electrodes cross the address electrodes such that the phosphor layers on the barrier ribs form a plurality of pixels. An optical filter is on a surface of the first substrate opposite the display electrodes. The optical filter includes a photochromic pattern having pattern elements spaced apart on the surface of the first substrate opposite the display electrodes, the photochromic pattern having a transmission characteristic wherein light transmission is changeable in response to intensity of external light. A support layer is on the pattern elements.

For the optical filter according to embodiments of the present invention, the light transmission of a stripe pattern made of a photochromic material may be changed according to the intensity of external light. The bright room contrast of the plasma display device may be improved since the reflection of external light may be minimized due to the low light transmission at an external light environment, and the luminance loss may be minimized due to the high light transmission under the external light-free condition.

Furthermore, the conventional optical filter has a disadvantage that viewing circumstances in a room with weak external light are restricted due to the fixed viewing angle. However, the optical filter according to embodiments of the present invention may have a more improved viewing angle range than the conventional optical filters since the photochromic pattern has a relatively higher light transmission at an indoor circumstance.

### BRIEF DESCRIPTION OF THE DRAWINGS

FIGS. 1 and 2 are perspective views showing an optical filter according to one embodiment of the present invention.

FIG. 3 is a cross-sectional view taken along line I1-I2 of FIG. 1, or along line I1′-I2′ of FIG. 2.

FIGS. 4, 5 and 6 are cross-sectional views showing an optical filter according to other embodiments of the present invention.

FIG. 7 is a graphic diagram illustrating changes in light transmission of a photochromic pattern.

FIG. 8 is a partial exploded perspective view showing a plasma display device having an optical filter according to one embodiment of the present invention.

### DETAILED DESCRIPTION

In the following detailed description, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Hereinafter, like reference numerals refer to like elements.

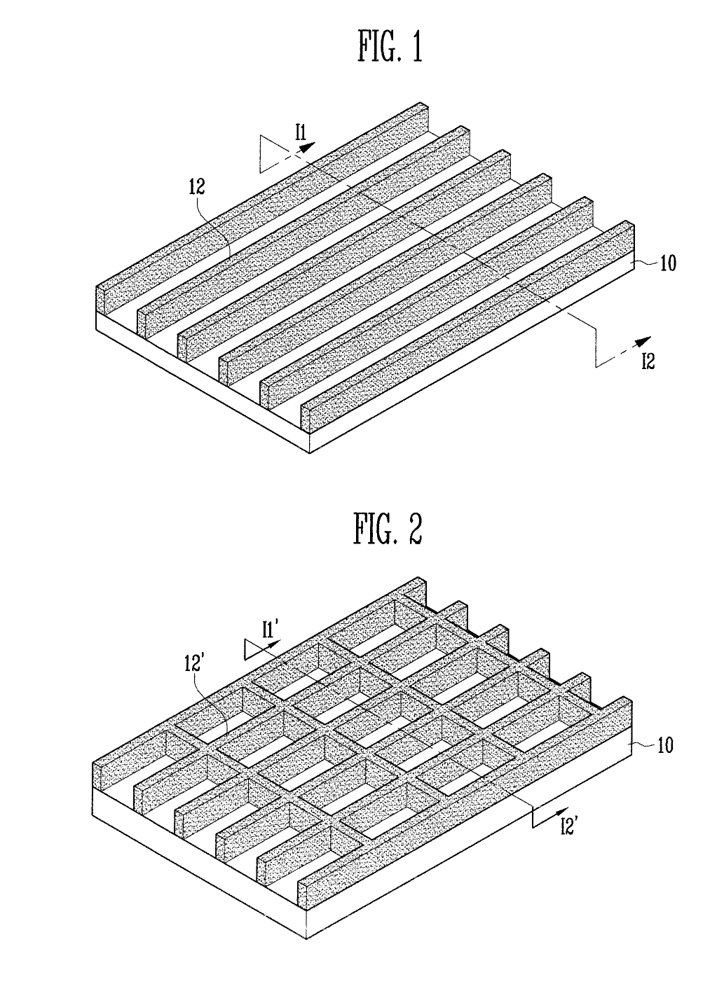

Referring to FIGS. 1 and 3, the optical filter according to one embodiment of the present invention includes a support layer 10, and a photochromic pattern 12 of stripes spaced apart on one surface of the support layer 10 and having a light transmission characteristic wherein light transmission is changeable according to the intensity of external light.

The support layer 10 is a base layer of the optical filter, and in an exemplary embodiment has high light transmission for minimizing the loss of transmitted light, and a low reflectance for preventing the reflection of external light, and also has a heat resistance and a predetermined strength. For example, the support layer 10 may formed in the shape of a transparent film having a light transmission of 80 to 99% and is made of one material selected from the group consisting of polyethyeleneterepthalate (PET), polycarbonate (PC), polyvinylchloride (PVC).

The photochromic pattern 12 includes a photochromic material whose light transmission is changeable in inverse proportion to the intensity of external light. Here, the photochromic material may include a composition including a spirobenzopyran compound, and the like.

The photochromic pattern 12 may be arranged in a stripe pattern as shown in FIG. 1, or arranged in a lattice or mesh shape photochromic pattern 12′ as shown in FIG. 2. In this case, the lattice or mesh shape photochromic pattern 12′ may have a quadrilateral or trapezoidal section shape.

Also, referring to FIG. 3, the photochromic patterns 12, 12′, in exemplary embodiments, may be formed having a height (h) of 20 to 200 μm, a width (w) of 5 to 50 μm for maximizing the light absorption, and a distance (d) between the stripes or lattice of the photochromic patterns 12, 12′ may be adjusted to a distance range from 50 to 300 μm in which a moire phenomenon does not occur.

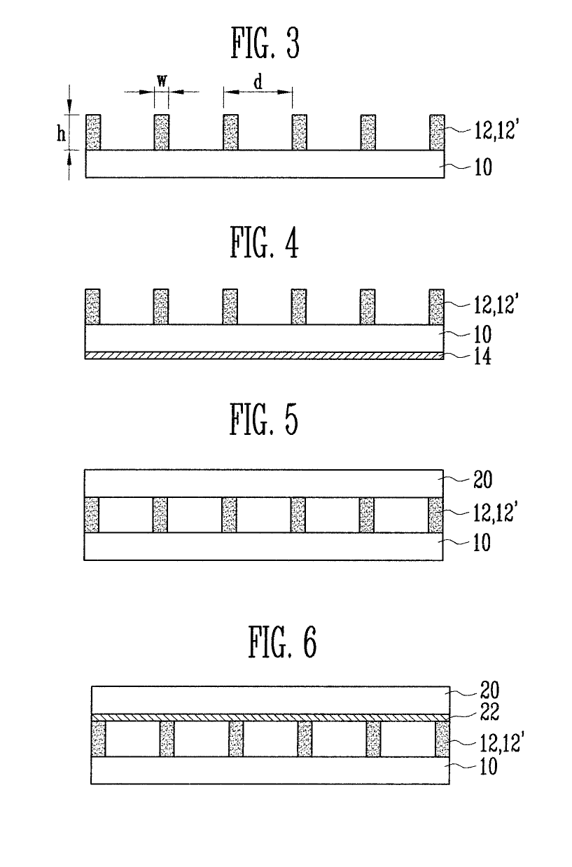

FIG. 4 is a cross-sectional view showing an optical filter according to another embodiment of the present invention. On the other surface of the support layer 10 is formed a functional film 14, such as a reflection supporting layer for preventing the reflection of light, or a hard coating layer for preventing scratches.

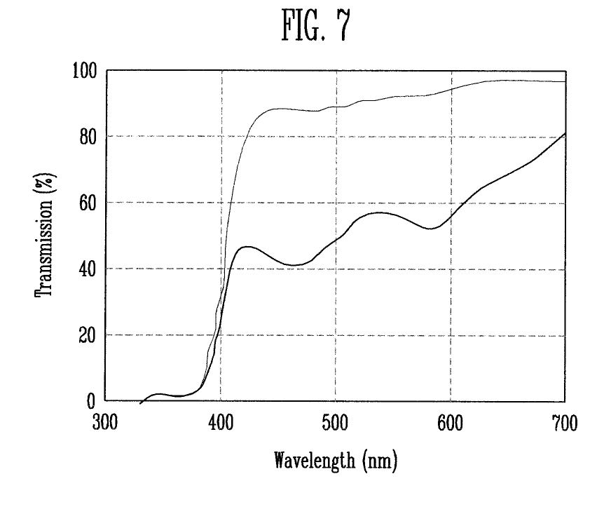

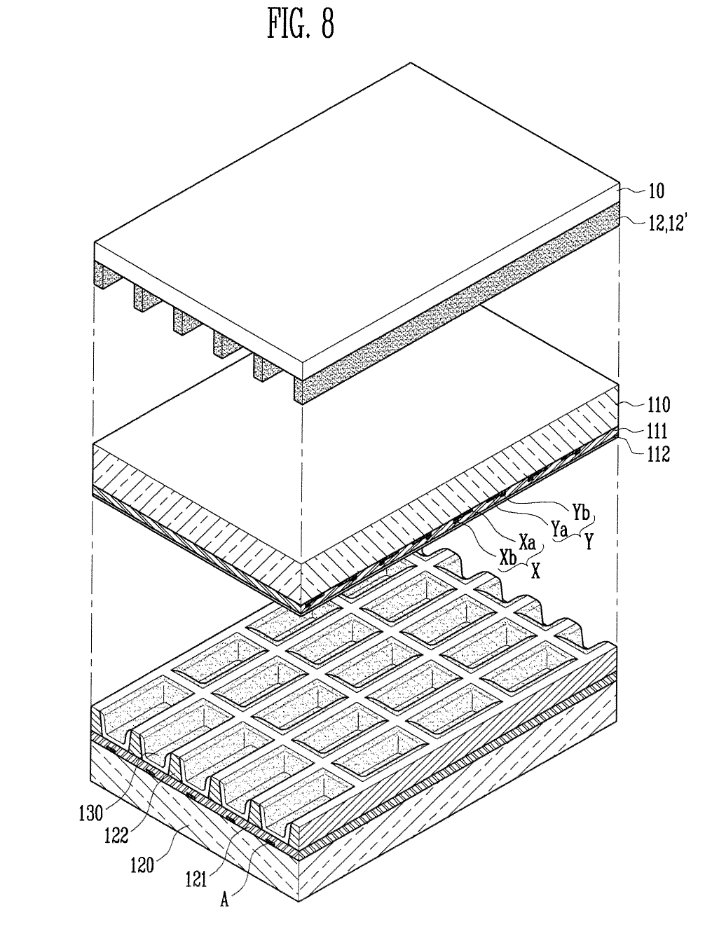

FIGS. 5 to. 6 are cross-sectional views showing an optical filter according to still other embodiments of the present invention. In FIG. 5, a transparent film 20 faces the support layer 10 based on the photochromic pattern 12, and, in FIG. 6, an electromagnetic shielding layer 22 is interposed between the transparent film 20 and the photochromic pattern 12. The electromagnetic shielding layer 22 is a structural body that cuts off electromagnetic waves emitted from the display device and is formed of an alloy including a transparent metal thin film, for example, platinum (Pt), silver (Ag), copper (Cu), aluminum (Al), nickel (Ni), molybdenum (Mo) or major components thereof, wherein the transparent metal thin film has a high electromagnetic wave shielding rate.

The transparent film 20 may be made of the same material as the support layer 10, and each of the layers such as the photochromic pattern 12, the functional film 14 and the like may be attached to the support layer 10 or the transparent film 20 using an acryl, silicon, urethane, polyvinyl transparent pressure sensitive adhesive or like adhesive (not shown).

As described above, the optical filter according to embodiments of the present invention includes a photochromic pattern 12, 12′ whose light transmission is changed in inverse proportion to the intensity of external light.

A photochromic material constituting the photochromic patterns 12, 12′ has characteristics that its colors are expressed, lost or changed according to the changes in refractive index since a basic structure of the photochromic material is changed when the light with various wavelengths is transmitted from the external environments. For example, Korean Patent Laid-open Publication No. 2000-0059500 (published on Oct. 5, 2000) discloses a spirobenzopyran compound as a photochromic compound and a method for manufacturing the same.

The photochromic material used in the present invention has a reversible reaction in which a certain color is expressed when it is structurally changed by the external light and returns into a transparent state when the external light is cut off. The photochromic material may show various colors according to the implementation methods, and, in an exemplary embodiment, has a blackish color so as to effectively reduce or cut off the reflection of external light.

FIG. 7 is a graph illustrating changes in light transmission of a photochromic pattern 12 formed of a spirobenzopyran compound. When the photochromic pattern 12 is exposed to the external light for 1 minute, the light transmission of the photochromic pattern 12 is reduced at respective wavelengths. The contrast of the optical filter may be improved when its light transmission is reduced by 10% or more.

FIG. 8 is a partial exploded perspective view showing the optical filter according to one embodiment of the present invention used in a plasma display device such as a 3-electrode PDP.

Referring to FIG. 8, the PDP includes a first substrate 110 and a second substrate 120 that are facing each other.

A plurality of sustain electrode lines (X) and scan electrode lines (Y) covered with a dielectric layer 111 and a protective layer 112 are formed on the first substrate 110 so that the sustain electrode lines (X) and scan electrode lines (Y) can be parallel with each other. The sustain electrode lines (X) and the scan electrode lines (Y) is composed of transparent electrodes (Xₐ and Yₐ) formed of indium tin oxide (ITO) and the like, and metal electrodes (X_{b} and Y_{b}) used to enhance the conductivity.

A plurality of address electrode lines (A) covered with a dielectric layer 121 are formed on the second substrate 120. Barrier ribs 122 are formed on the dielectric layer 121 disposed between a plurality of the address electrode lines (A) so that the barrier ribs 122 can be parallel to the address electrode lines (A), and phosphor layers 130 are formed in both sides of the barrier ribs 122 and on the dielectric layer 121.

The first substrate 110 and the second substrate 120 are attached to each other so that the sustain electrode lines (X) and the scan electrode lines (Y) can be arranged crossing the address electrode lines (A), and a plurality of pixels are then formed by sealing a gas for forming plasma in a closed discharge space formed by the barrier ribs 122.

The PDP thus configured realizes an address discharge by applying an address voltage between the address electrode lines (A) and either ones of the sustain electrode lines (X) or the scan electrode lines (Y). A sustain discharge occurs by applying a sustain voltage between a pair of the sustain electrode lines (X) and the scan electrode lines (Y). The vacuum ultraviolet rays generated in the sustain discharge excite a corresponding phosphor layer 130 to emit visible light through the transparent first substrate 110.

The optical filter according to one embodiment of the present invention is attached to the first substrate 110 of the PDP thus configured. In the case of the optical filter as shown in FIG. 1 or 2, a surface of the photochromic pattern 12 may be attached to the first substrate 110 using a pressure sensitive adhesive layer or an adhesive layer. Also in the case of the optical filter as shown in FIG. 5 or 6, a surface of the transparent film 20 may be attached to the first substrate 110 using a pressure sensitive adhesive layer or an adhesive layer.

For example, when an optical filter with 60% light transmission is attached to a display panel having a luminance value of 100 cd/m², the luminance of the resulting display panel is calculated to be 60 cd/m². That is to say, since the calculated luminance is determined by the light transmission of the optical filter, the conventional optical filter loses a luminance of approximately 40 cd/m² under the external light-free condition.

However, in the case of the display device using the optical filter according to embodiments of the present invention, the photochromic pattern 120 sustains a light transmission of 80 to 90% or more under the external light-free condition. Therefore, since the display device using the optical filter according to embodiments of the present invention may have an increased luminance effect by approximately 40% since the display device shows a high luminance of approximately 80 to 90 cd/m². As a result of the increased luminance, the visibility and visual effects of the display device may be improved even under minimal external light. In particular, the use of photochromic material having high UV discoloring characteristics may maximize the visual effects in typical living environments, and also provide a bright screen. Also, since the light transmission of the photochromic pattern 12 is maintained to a low light transmission level under the external light environment, the reflection of external light is reduced by the light absorption effect, which makes it possible for a display device to have a high bright room contrast.

Further, the conventional optical filter has a fixed viewing angle as an initial set value, but the optical filter according to one embodiment of the present invention has a viewing angle that may be changed according to the external light. For example, the viewing circumstances in a room with weak external light may be restricted since a viewing angle of a currently used display device is fixed within an angle range from 120 to 125°. However, the optical filter according to one embodiment of the present invention may reduce its viewing angle limit since the photochromic pattern 120 has a relatively higher light transmission in the room with weak external light.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An optical filter, comprising:
a support layer; and
a photochromic pattern having pattern elements spaced apart on a surface of the support layer, the photochromic pattern having a light transmission characteristic wherein light transmission is changeable in response to intensity of external light.

2. The optical filter according to claim 1, wherein the support layer has a light transmission of 80 to 99%.

3. The optical filter according to claim 1, wherein the light transmission of the photochromic pattern is changeable in inverse proportion to the intensity of external light.

4. The optical filter according to claim 1,
wherein the photochromic pattern is in a stripe shape or lattice shape and has a quadrilateral or trapezoidal cross section, and
wherein the pattern elements form stripes or a lattice.

5. The optical filter according to claim 1, wherein the photochromic pattern comprises a spirobenzopyran compound.

6. The optical filter according to claim 1, wherein the photochromic pattern comprises a height ranging from 20 to 200 μm, a width ranging from 5 to 50 μm, and a distance between the photochromic patterns ranging from 50 to 300 μm.

7. The optical filter according to claim 1, further comprising a reflection supporting layer on the other surface of the support layer.

8. The optical filter according to claim 1, further comprising a transparent film on the photochromic pattern opposite the support layer.

9. The optical filter of claim 1, further comprising:
an electromagnetic shielding layer on the photochromic pattern opposite the support layer; and
a transparent film on the electromagnetic shielding layer.

10. The optical filter of claim 1, further comprising a reflection supporting layer on the supporting layer opposite the photochromic layer.

11. The optical filter of claim 1, further comprising a hard coating layer on the supporting layer opposite the photochromic layer.

12. A plasma display device comprising:
a first substrate having a plurality of display electrodes on the first substrate;
a second substrate having a plurality of address electrodes on the second substrate;
barrier ribs both between the first substrate and the second substrate and between the address electrode lines;
phosphor layers on the barrier ribs, the first substrate and the second substrate being attached to each other and having the display electrodes cross the address electrodes such that the phosphor layers on the barrier ribs form a plurality of pixels; and
an optical filter on a surface of the first substrate opposite the display electrodes,
wherein the optical filter comprises:
a photochromic pattern having pattern elements spaced apart on the surface of the first substrate opposite the display electrodes, the photochromic pattern having a light transmission characteristic wherein light transmission is changeable in response to intensity of external light; and
a support layer on the pattern elements.
